(19) United States
(12) Patent Application Publication
(10) Pub. No.: US 2005/0246212 A1
(43) Pub. Date: Nov. 3, 2005

(54) Process navigator

(76) Inventors: Nathanael P. Shedd, Titusville, FL (US); Frank Gutcher, Titusville, FL (US)

Correspondence Address: BLACK LOWE & GRAHAM, PLLC, 701 FIFTH AVENUE, SUITE 4800, SEATTLE, WA, 98104, US

(21) Appl. No.: 10/835,375

(22) Filed: Apr. 29, 2004

(51) Int. Cl. G06F 17/60

(52) U.S. Cl. 705/7

(57) ABSTRACT

Embodiments of the present invention provide methods, computer-readable media, and systems for coordinating and managing a process. A task involved in the process is identified. At least one resource involved in the task is identified. The at least one resource is associated with the task. A location of the resource from which the at least one resource can be accessed is specified. A completion indicator provides for completion of a task to be indicated. A task review interface provides for ascertainment of completion of the task. A resource interface provides for review of the resources involved in the task.

### FIELD OF THE INVENTION

This invention relates generally to process management and, more specifically, to tools for organizing and monitoring project resources and progress.

### BACKGROUND OF THE INVENTION

As is well understood, management of a project is seldom simple. To consider just one example, management of software development presents a complicated process. A great deal of time and skill required to identify functional requirements for software, to plan the function of the software, and, most of all, to develop and code the software.

Careful organization is very important to the success of any software development effort. For example, in the thousands and thousands of lines of code that ultimately may be created in developing a software program, attention must be paid to how data values are being written, stored, processed, and passed between modules. Further, attention must be paid to the allocation of memory and other resources so that different modules of the software can operate appropriately to achieve a desired result.

Although the need for organization within the software itself is well understood, the need for organization of resources involved in the development effort may not be as fully appreciated. Completion of various phases should be tracked. Completion of phases of the project may be particularly important when some software modules depend on the completion of other modules, such as when a second module must be aware of the status of data processed by a preceding module. In addition, when software is being developed by a team of designers and programmers, a great number of documents—both computer-readable and physical documents—and other resources may be needed by various members of the team. Further, various documents, templates, charts, and other artifacts are likely to be generated during the development process, and these newly created resources will have to be made available to other team members.

Resources needed for arid generated during the development process need to be clearly identified so that needed the information they contain will not be overlooked. Team members will need to know how they can access these resources. Similarly, team members should have a structured way to communicate with each other about the tasks and these resources.

This type of process organization is highly important as development teams seek to produce software of the highest quality. The Software Engineering Institute (SEI) has promulgated ratings such as the Capability Maturity Model® (CMM) levels that specify the standards to be met to achieve desired quality levels. These levels involve measurements that are taken and used throughout the development model to evaluate the maturity level of the software by providing visibility and accountability in the development process. Software developers and their clients increasingly demand that higher SEI CMM Levels be met.

The higher CMM Levels require higher degrees of organization and measurement in the process. For example, CMM Level 2 involves setting measurement goals that may be derived from best guesses. These best guesses are then used to evaluate the progress of the process. These CMM Level 2 goals may provide a useful, after-the-fact metric by which the process can be evaluated, and may provide some insight for similar future projects.

By contrast, CMM Level 3 demands a higher degree of precision in setting objectives. CMM Level 3 requires establishment of thresholds based on historical data rather than just guesses. More significantly, CMM Level 3 thresholds are not used merely as after-the-fact measurements, but represent in-process metrics that require ongoing review. Further, when these thresholds are missed, CMM Level 3 calls for corrective actions to be taken to get the project back on course. CMM Level 4, not surprisingly, involves an even more stringent level of in-process planning, measurement, and scrutiny.

To achieve these levels, project planners need to do perform careful planning and measuring, and need better tools to assist them. Thus, there is an unmet need in the art for methods and systems for projects such as software development for improving resource identification and tracking, as well as monitoring the progress of the project.

### SUMMARY OF THE INVENTION

Embodiments of the present invention are useful in managing phases and resources used in and created throughout a project. Embodiments of the present invention provide a graphical-user-interface-based process navigator. In one embodiment, a process navigator collects tasks in a hierarchical tree to allow for intuitive navigation through the process tasks. The process navigator therefore allows the software development process to be monitored and reviewed in an organized manner. Documents, development tools, and other needed resources are associated with each appropriate task in the hierarchical tree. As a result, selection of each task presents a complete table of resources, resource names, locations, and a description of the resource, associated with the task. The table thus presents a complete list of resources needed to complete the task and/or resources that will be generated by the task. Thus, the process navigator allows for the resources used in or produced by each task to be readily identified. The process navigator preferably includes a multi-user application so that multiple members of a development team can access the process navigator as well as communicate with each other through appropriate entries submitted to the process navigator.

More particularly, embodiments of the present invention provide methods, computer-readable media, and systems for coordinating and managing a process. A task involved in the process is identified. At least one resource involved in the task is identified. The at least one resource is associated with the task. A location of the resource from which the at least one resource can be accessed is specified. A completion indicator provides for completion of a task to be indicated. A task review interface provides for ascertainment of completion of the task. A resource interface provides for review of the resources involved in the task.

### BRIEF DESCRIPTION OF THE DRAWINGS

The preferred and alternative embodiments of the present invention are described in detail below with reference to the following drawings.

FIG. 1 is a flowchart of an exemplary routine according to an embodiment of a present invention;

FIGS. 2-10 are screen shots representing steps in the routine of FIG. 1; and

FIG. 11 is a block diagram of a system according to an embodiment of the present invention.

### DETAILED DESCRIPTION

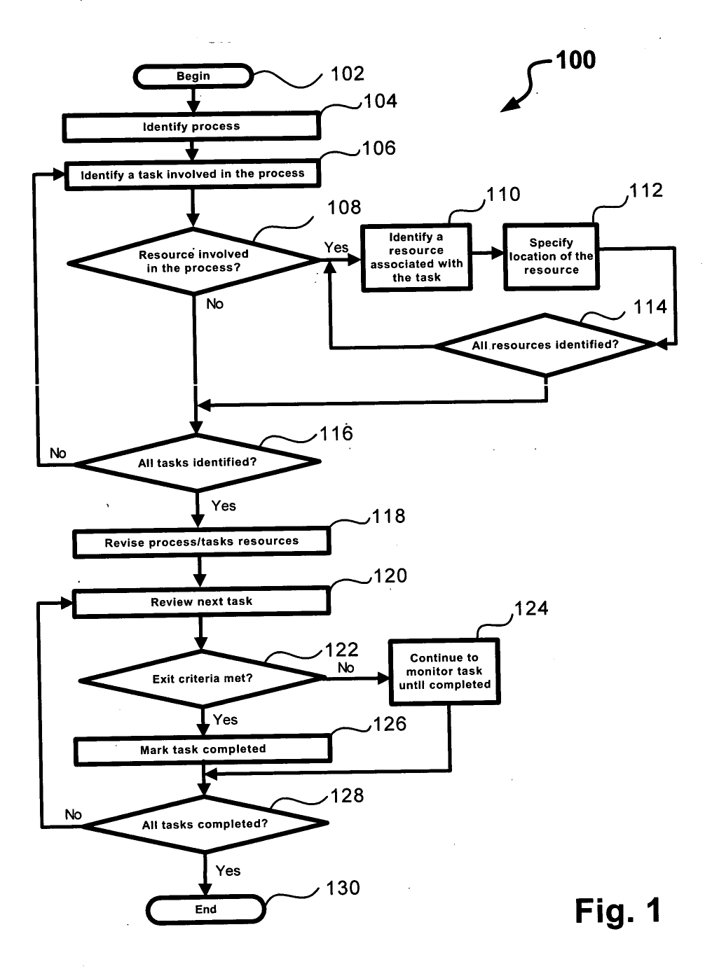

The invention relates generally to process management and, more specifically, to monitoring tasks and resources associated with those tasks. Many specific details of certain embodiments of the invention are set forth in the following description and in FIGS. 1-11 to provide a thorough understanding of such embodiments. One skilled in the art, however, will understand that the present invention may have additional embodiments, or that the present invention may be practiced without several of the details described in the following description.

More particularly, embodiments of the present invention provide methods, computer-readable media, and systems for coordinating and managing a process. In one embodiment, a method includes identifying a task involved in the process. At least one resource involved in the task is identified. The at least one resource is associated with the task. A location of the resource from which the at least one resource can be accessed is specified. A completion indicator provides for completion of a task to be indicated. A task review interface provides for ascertainment of completion of the task. A resource interface provides for review of the resources involved in the task.

In the following description of embodiments of the present invention, the process being monitored includes a software development process. As will be appreciated by one ordinarily skilled in the art, a software development process includes a plurality of steps including determining requirements, functional organization, process flow, pseudo-coding, coding, testing, documenting, and a multitude of other possible steps. A task might include creating of a particular functional module. Subtasks, therefore, might include designing the module, pseudo-coding the module, coding the module, testing the module, documenting the operation of the module, and documenting what input data is used by the module and what output data is generated or processed by the module. Resources involved in the completion of the tasks or subtasks might include input resources such as specifications and available data as well as output resources such as testing verification and user documentation. However, it will be appreciated that the process for which embodiments of the present invention is being used can include any other types of processes, tasks, and resources (e.g. multi-step manufacturing processes, etc.).

FIG. 1 is a flowchart of an embodiment according to the present invention of a routine 100 for monitoring tasks and resources involved in a process such as, by way of non-limiting, example, a software development process. The method is implemented using an interactive computer program. The computer program uses a graphical user interface which, as is understood in the art, allows a user to select options with a pointing device.

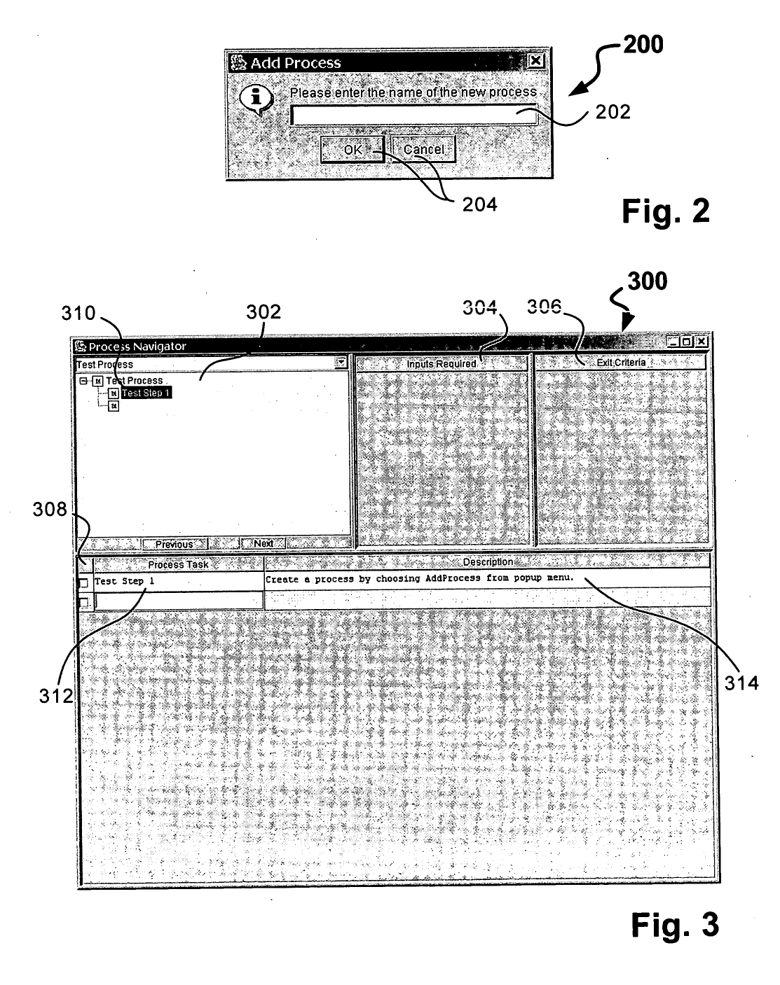

The routine 100 begins at a block 102. At a block 104, a process to be monitored according to the routine is identified. FIG. 2 shows a dialog box 200 for identifying the routine. The dialog box 200 is of a style familiar to those using computer programs with a graphical interface. The dialog box 200 includes a process identification field 202 where a name or other identifier of the process is entered. On-screen buttons 204 allow the user to confirm or cancel the process identification step.

Referring back to FIG. 1, at a block 106 a task involved in the process is identified. The identification of the tasks and identification of subtasks allows for a hierarchical organization of the process being monitored according to the routine 100 to be created.

FIG. 3 shows a process navigator interface 300 for identifying tasks and subtasks in accordance with an embodiment of the invention. The interface screen 300 includes a task interface window 302. As will be further described, the task interface window 302 presents a hierarchically-organized list of tasks and subtasks involved in the process. The interface screen 300 also includes a resource interface 304 that is operable to display resources involved in a task or subtask identified in the task interface. The interface screen 300 also includes an exit criteria interface 306 that is operable to display conditions or criteria that will signify the task has been completed.

The process navigator interface 300 also includes a task detail interface 308. The task detail interface 308 presents a task name field 312 matching the task name in the task interface 302 for the selected task. A task description field 314 allows for a description, status, and other information about the task to be presented.

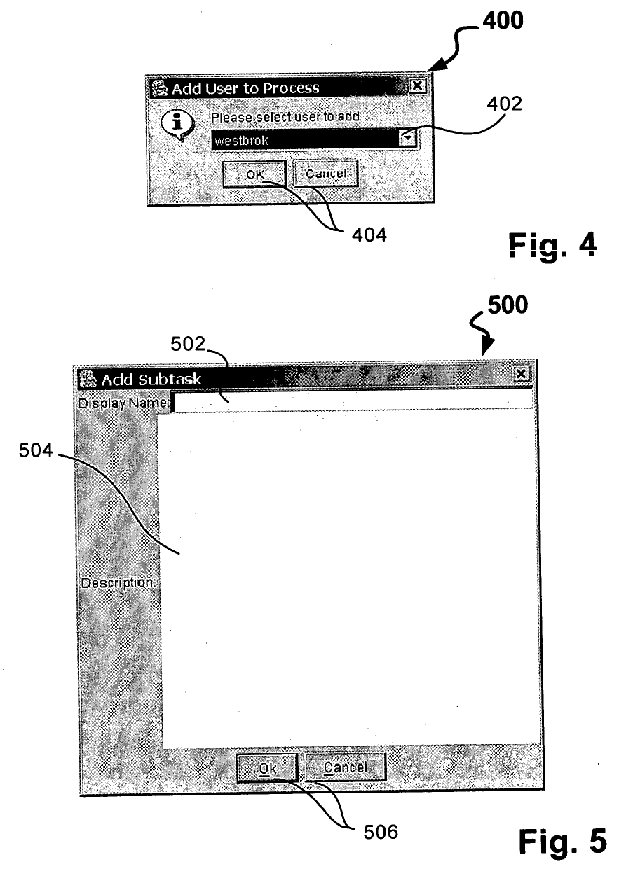

With this information organized in a central, organized repository, it will be appreciated that it may be desirable for multiple team members, reviewers, managers, auditors, or other personnel to be able to review the information about the tasks, resources, and other information presented in the process navigator interface 300. Thus, in one embodiment of the invention, a multiple-user interface is provided to allow multiple users to access the information on a computer system or via a networked computer system. FIG. 4 shows an add user dialog box 400 wherein a user with supervisory access can add the name or other identifier for a user who can access the information represented in the interface screen. The add user dialog box includes a user identification field 402 where a name or other identifier of the user to be added is entered. On-screen buttons 404 allow the user to confirm or cancel the add user step.

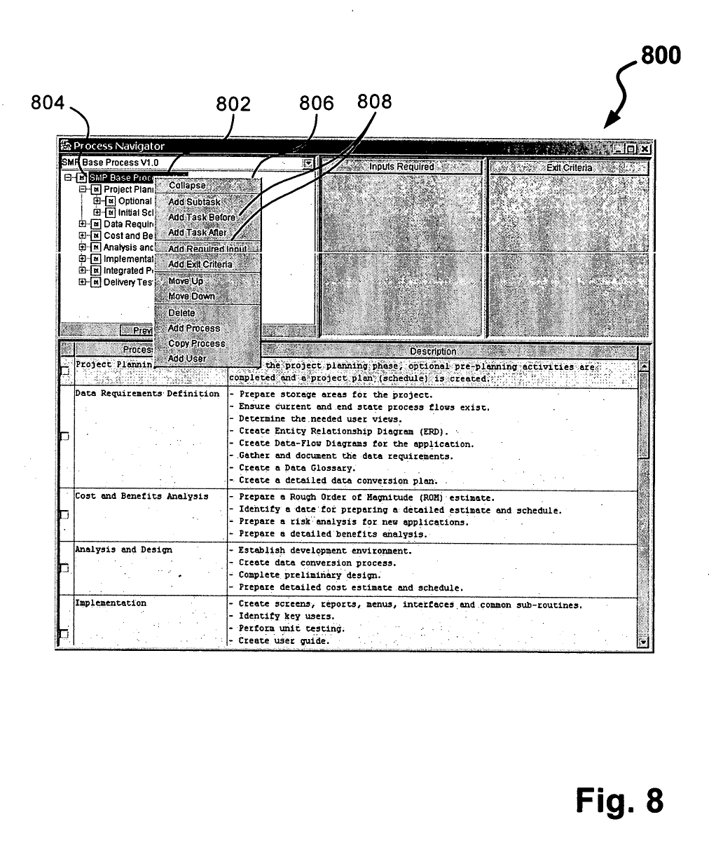

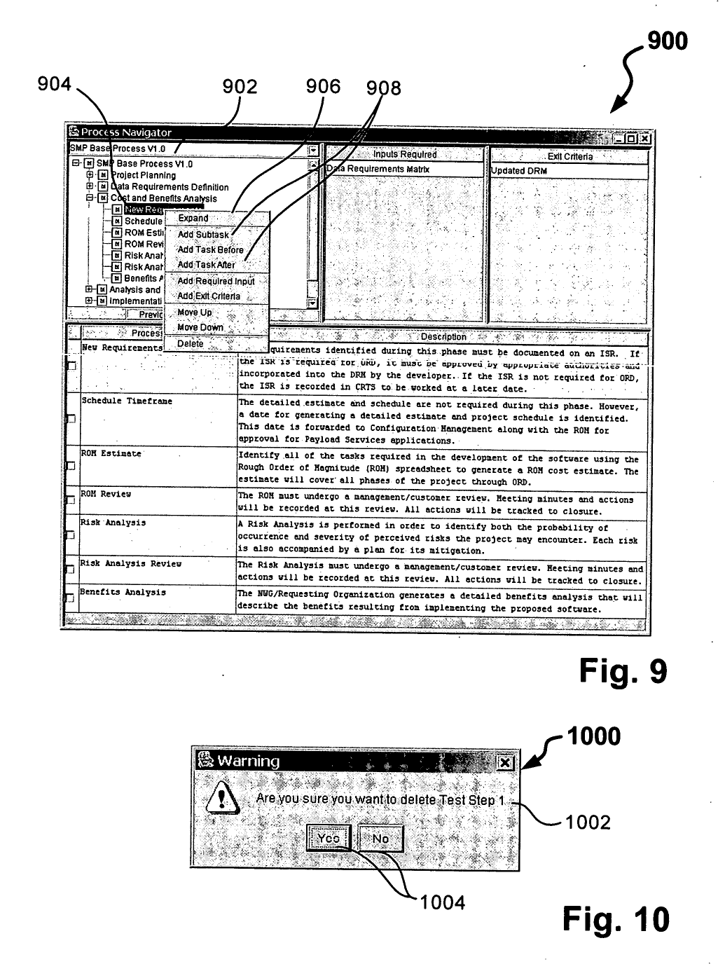

In one preferred embodiment, the add user interface 400 and other tools can be invoked from a menu bar, a keystroke sequence, or by invoking a pop-up menu. The use of pop-up menus is described further below in connection with FIGS. 8 and 9.

FIG. 5 shows an add task interface 500. The add task interface 500 is used to add tasks and/or subtasks to the hierarchy of tasks shown in the task interface 302. The add interface 500 includes a task field 502 where a task or subtask can be entered. The add task interface 500 also includes a description field 504. The description field 504 allows a user to create or revise the description of the task. On-screen buttons 506 allow the user to confirm or cancel the add task step. The task and its description entered or revised here will be presented in the process navigator interface 300 in the task name field 312 and the task description field 314, respectively.

Referring back to FIG. 1, once the task or subtask has been identified at the block 106, at a decision block 108 it is determined if there are resources involved in the process. If so, at a block 110, the resource associated with the task is identified. At a block 112, a location of the resource is specified so that the resource can be located by someone intending to use the resource. At a decision block 114, it is determined if all the resources associated with the task have been identified. If not, the routine 100 loops back to the block 110 for the next resource to be identified.

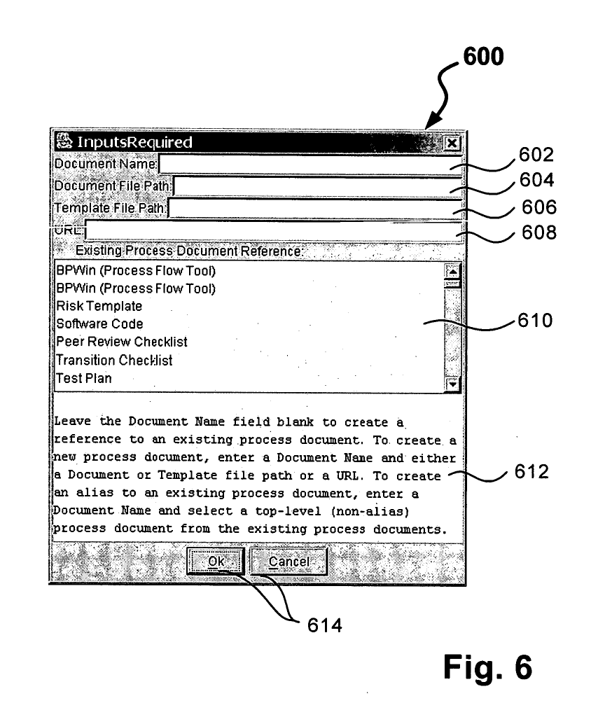

FIG. 6 shows a resource interface 600. The resource interface 600 allows resources involved in the task to be identified and otherwise described so that all resources are effectively collected in the task hierarchy in the task interface 302. The resource interface 600 includes a name field 602 where, for example, a name of a document involved in the task is inserted. The document named may be a requirements or specifications document, a manual, or other information involved in the task or subtask.

In addition to naming the document in the name field 602, the resource detail interface 600 allows for the location of the resource to be specified. In the resource detail interface 600 of FIG. 6, it is assumed the resource is a computer-readable document. If the document is a document on the same computing system or a networked computing system, a document path permitting the document to be electronically retrieved is input in the document file path field 604. The document file path entered can be used to retrieve the document. On the other hand, if the resource is a document template from which further working documents are to be created, the file path to the template is inserted into the template file path field 606. Once the template file path is inserted into the template file path field 606, the template can be retrieved from storage on the computing system or storage on a network computing system. Alternatively, if the resource is a web-based document, a uniform resource locator (URL) for the document is entered into the URL field 608. The URL allows the document, whether a privately- or publicly-accessible document, to be retrieved from the web. Non-computer-readable resources also can be associated with a task, the location of the resource being specifiable in a manner comparable to that for specifying locations of computer-readable resources. It will be appreciated that non-computer-readable resources will be obtained physically because such resources cannot be accessed directly via a computer.

The resource detail interface 600 also includes an existing resource list 610. If the task being associated with documents involves a resource that already has been described, the user can choose the description 612 from the existing resource list 610 instead of having to re-enter the description and location of the document.

In a preferred embodiment of the invention, the resource detail interface 600 (and other interfaces) includes on-screen help to assist a user in creating and detailing the process/task hierarchy. As other interfaces already described, the resource detail interface 600 also includes on-screen buttons 614 to allow the user to confirm or cancel the resource identification step.

Once it has been determined at the decision block 108 that no resources are involved in the task, or determined at the decision block 114 that all the resources have been identified, then at the block 116 it is determined if all the tasks or subtasks have been identified. If not, the routine 100 loops to the block 106 to identify another task or subtask. If so, the routine 100 proceeds to the block 118 where the user can review or revise the tasks, resources, and other aspects of the process. It will be appreciated that revisions to the process, tasks, or resources can be made at any point during or after creation of the task hierarchy, not just only upon first completing the hierarchy.

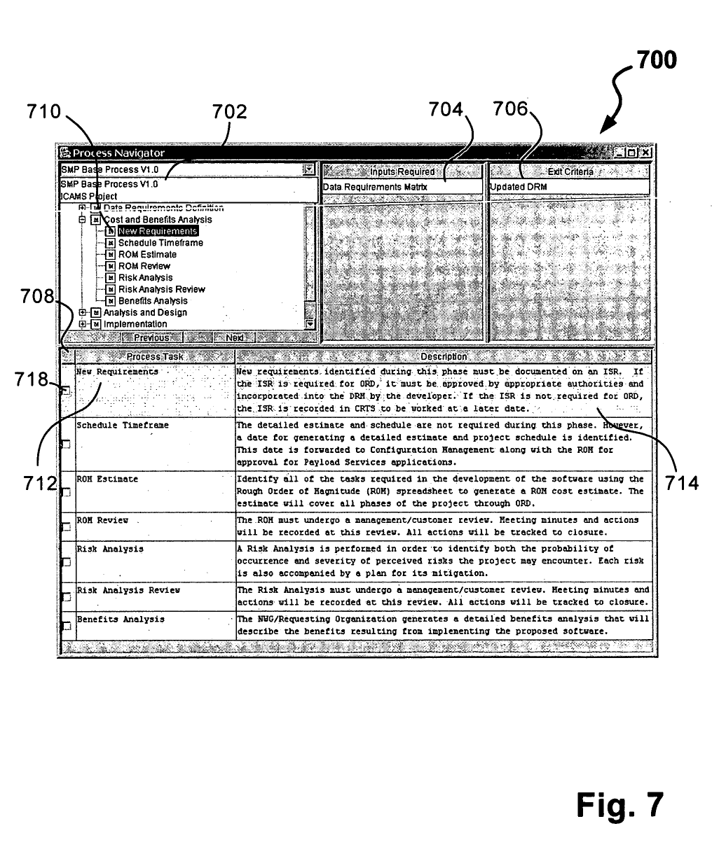

Once all the tasks and subtasks have been identified and described, resources have been identified, associated with tasks, and had their locations specified, then at a block 120 the tasks in the process are reviewed to monitor the process. FIG. 7 shows an exemplary process navigator interface 700 showing a sample hierarchy of tasks and subtasks, resources, and other information. Using the process navigator interface 700, a user can effectively monitor and review the process. In a task interface 702, different projects (e.g. SMP Base Process V1.0, ICAMS Project, etc.) and their associated subtasks can be reviewed. To review each task, the user selects a task such as the “New Requirements” task 710. Once the task 710 is selected, resources involved in the task are displayed in the resource interface 704. As will be familiar to users of Microsoft Windows®-based graphical user interface programs, double-clicking the left mouse button on a resource opens the referenced file, document, template, executable or web-address that was previously defined in resource interface 600. The user can then use the resource to complete the task. Conditions or criteria that are to be met before the task can be considered complete are listed in an exit criteria interface 706.

As also can be seen in the process navigator interface 700, the selected task 710 is highlighted in a task detail interface 708. The name of the selected task is highlighted in the task name field 712, and the description of the selected task is highlighted in a task description field 714 allows for a description, status, and other information about the task to be presented. The name of the task is shown in a task description interface 708.

Referring back to FIG. 1, while reviewing a task at the block 120, at a decision block 122 it is determined if the exit criteria signaling completion of the task. If it is determined at the decision block 122 that the exit criteria have been met, at a block 126 the user can select to mark the task as completed. On the other hand, if it is determined at the decision block 122 that not all the exit criteria have been met, at a block 124, the task will be further monitored, and the routine proceeds to a decision block 128.

In one particular embodiment, the task is highlighted in the task table first. Next, any documents, templates, manuals, or applications that may be needed to accomplish the task are displayed in the “Inputs Required” table. And finally, any documents that are produced or updated in performing the task are displayed in the “Exit Criteria”. The items in the “Inputs Required” and “Exit Criteria” tables can describe physical objects, such as a folder in a filing cabinet, or they can reference electronic items, such as:
1) A file on a disk or server whose file type is associated with a windows application. When the user clicks on these items in the table, the associated application is run and the file is opened inside the application;
2) A template file on a disk or server whose file type is associated with a windows application. When the user clicks on these items in the table, a copy of the template is made and the associated application is run and the template copy is opened inside the application. Subsequent clicks on these items will open the existing template copy;
3) A Universal Resource Locator (URL) that points to a document on the world wide web. When the user clicks on one of these items, the default web browser will be opened at the given URL address; and
4) An executable file on the user's PC or a server. Selecting this item will cause the application to be run. With these capabilities, the developer can quickly access the things that he needs to do his job and keep track of the results of his work.

FIG. 7 shows how the process navigator interface 700 is used to monitor satisfaction of exit criteria. For the selected task 710, exit criteria for the selected task are displayed in the exit criteria interface 706. As will be familiar to users of Microsoft Windows®-based graphical user interface programs, double-clicking the left mouse button on an exit criteria opens the referenced file, document, executable or web-address that was previously defined in resource interface 600. The user can then review the listed exit criteria to determine if the task has been completed. If so, the user may indicate the task has been completed by using a pointing device (not shown) to select a checkbox 718 associated with the task in the task detail interface 708. If the exit criteria are not satisfied, the user leaves the checkbox 718 unchecked signifying that other criteria must be met before the selected task 710 is completed.

FIG. 8 shows how a user may interact with a process navigator interface 800 to modify the process hierarchy. In a task interface 802 of the process navigator interface 800, a task 804 is selected and a pop-up menu 806 is activated. As will be familiar to users of Microsoft Windows®-based graphical user interface programs, selecting an on-screen option with a right-button mouse click selects the item marked by an on-screen cursor and invokes a context-sensitive pop-up menu that allows the user to modify or otherwise interact with the item. A user then can scroll over the listed items to select an item from the list and left-button mouse click on a selected item listed to execute the highlighted option.

In the case of the pop-up menu 806, the pop-up menu 806 is activated in connection with a task 804 listed in the task interface 802. Accordingly, the options 808 listed in the pop-up menu 806 relate to task manipulation. As can be seen in the pop-up menu 806, listed options 808 include collapsing the subtasks under the task to simplify the hierarchy view, adding a subtask, adding a new task before or after the selected task 804, and other options. If the user selects to add a new task or subtask before or after, the add task interface 500 (FIG. 5) is presented so that the task can be named and described. The task or subtask is then inserted into the task hierarchy at the selected location. Alternatively, if the user selects to add a “required input” or other resource, the user will be presented with the resource detail interface 600 (FIG. 6) to add a resource. Similarly, tasks can be deleted, users can be added, and other options 808 listed in the pop-up menu can be performed.

FIG. 9 shows how a user may interact with a process navigator interface 900 to modify subtasks within the hierarchy. In a task interface 902 of the process navigator interface 900, this time a subtask 904 is selected and a pop-up menu 906 is activated. By comparison with the pop-up menu 806 of FIG. 8, it will be appreciated that the context-sensitive pop-up menu 906 is different from that of the pop-up menu 806. The pop-up menu 906 lists options 908 including an option to expand the hierarchy, add subtasks, and other options. However, because the user has selected a subtask 904, the user is not provided options to, for example, create a new process. Because the user is working with a selected subtask, it is not considered appropriate to give the user that option, thus, the pop-up menu 906 is tailored to the context.

One option presented on both the pop-up menu 806 (FIG. 8) and the pop-up menu 906 (FIG. 9) is a delete option allowing the task or subtask to be deleted. To ensure against loss of work because of an errant mouse-click, a confirmation window 1000 (FIG. 10) may be appropriate. Before the task or subtask is deleted, the confirmation window 1000 is presented to display a cautionary message 1002 making sure the user intended to delete the selected task or subtask. On-screen buttons 1004 allow the user to confirm or cancel the add user step.

Referring back to FIG. 1, at a decision block 128 it is determined if all the tasks in the process have been completed as previously described. If not, the routine 100 loops to the block 120 to review the next task. On the other hand, if all the tasks have been completed, the routine 100 ends at a block 130.

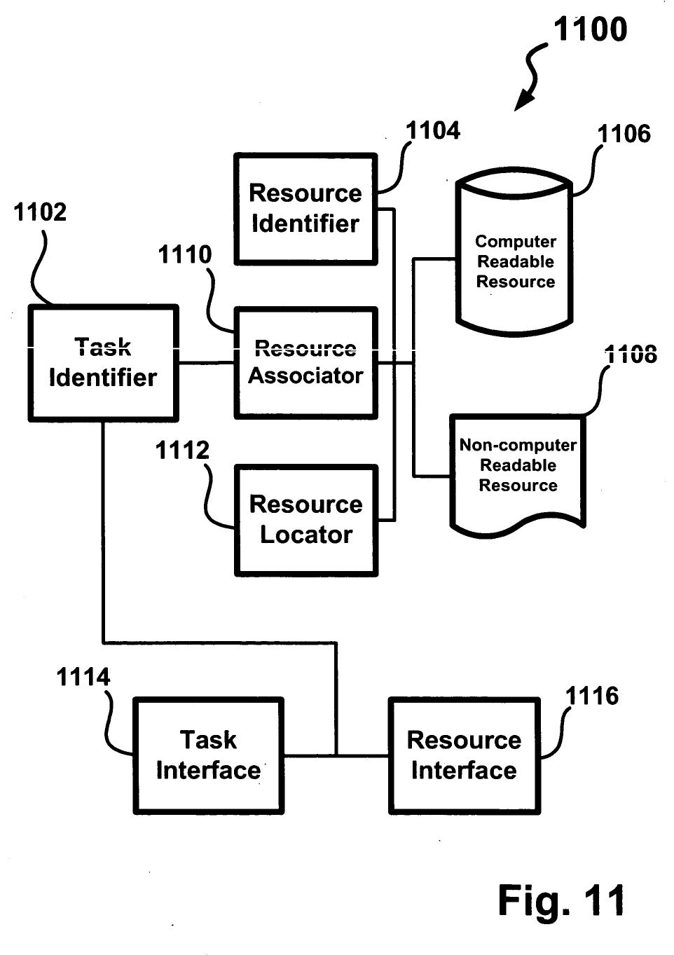

FIG. 11 shows a block diagram of a system 1100 according to an embodiment of the present invention. The system 1100 operates comparably with the routine 100 (FIG. 1). The system 1100 includes a task identifier 1102 used to identify tasks and subtasks involved in the process. The task identifier is coupled with a resource identifier 1104. The resource identifier 1104 allows for both computer-readable resources 1106 and non-computer-readable resources 1108 to be specified. A resource associator 1110 coupled with the task identifier 1102 allows the resources to be associated with one or more tasks or subtasks to show what resources are involved with each task and subtask. A resource locator 1112 coupled with the task identifier 1102 presents a location for each associated resource facilitating access to desired resources.

A task interface 1114 is coupled with the task identifier 1102 allowing a user to review tasks and subtasks in the process hierarchy. Also joined with the task identifier 1112 is a resource interface 1116 to facilitate access to resources described by the resource identifier 1104, the resource associator 1110, and the resource locator 1112.

While preferred and alternate embodiments of the invention have been illustrated and described, as noted above, many changes can be made without departing from the spirit and scope of the invention. Accordingly, the scope of the invention is not limited by the disclosure of the preferred and alternate embodiments. Instead, the invention should be determined entirely by reference to the claims that follow.

1. A method for coordinating and managing a process, the method comprising:
identifying a task involved in the process;
identifying at least one resource involved in the task;
associating the at least one resource with the task;
specifying a location of the resource from which the at least one resource can be accessed;
providing a completion indicator by which completion of the task is indicated;
providing a task review interface by which the completion of the task is ascertainable; and
providing a resource interface by which resources involved in the task are reviewable:

2. The method of claim 1, wherein the resource is a computer-readable resource stored on a computing system.

3. The method of claim 1, wherein the location of the resource includes a uniform resource locator.

4. The method of claim 1, wherein the process includes a plurality of hierarchically organized tasks such that at least one main task includes at least one subtask including a constituent part of the main task.

5. The method of claim 1, further comprising a hierarchy interface operable to display a hierarchy of tasks and subtasks.

6. The method of claim 5, wherein the hierarchy interface is operable to allow the hierarchy of tasks and subtasks to be one of selectively displayed, hidden, collapsed, and expanded.

7. The method of claim 6, wherein the hierarchy interface is operable for a user to one of create a task, revise a task, re-associate a task with another task, and delete a task.

8. The method of claim 1, further comprising a task description interface operable to one of allow a user to create a description of a selected task, allow a user to revise the description of the selected task, and display a description of a selected task.

9. The method of claim 1, further comprising a resource interface operable to display at least one of an input resource and an output resource.

10. The method of claim 1, further comprising presenting an exit criteria interface operable to display results to be achieved for a task to be completed.

11. The method of claim 1, wherein the completion indicator includes a checkbox such that operator actuation of the checkbox signifies that the task is completed.

12. The method of claim 1, further comprising using a graphical user interface such that a user can select a task or a resource using a pointing device.

13. The method of claim 12, further comprising generating a pop-up menu providing a list of options for one of the task and the resource selected by the user.

14. The method of claim 13, further comprising navigation buttons including a forward button allowing the user to step forward to a next task and a backward button allowing the user to step backward to a previous task.

15. The method of claim 1, further comprising providing multiple-user access allowing a plurality of permitted users to monitor the process.

16. The method of claim 15, further comprising a user control interface operable to selectively allow for access for monitoring the process to be granted, revoked, and changed.

17. A method for coordinating and managing a process, the method comprising:
identifying a plurality of hierarchically organized tasks involved in the process;
presenting a hierarchy interface operable to display a hierarchy including a plurality of tasks;
presenting a task description interface operable to display a task name and a task description;
identifying at least one resource involved in the task;
associating the at least one resource with the task;
presenting a resource interface operable to display the at least one resource when the task is selected by a user;
providing a completion indicator by which completion of the task is indicated; and
providing a task review interface by which the completion of the task is ascertainable.

18. The method of claim 17, wherein the resource is a computer-readable resource stored on a computing system.

19. The method of claim 17, wherein the location of the resource includes a uniform resource locator.

20. The method of claim 17, wherein the hierarchy interface is operable to allow the hierarchy of tasks and subtasks to be one of selectively displayed, hidden, collapsed, and expanded.

21. The method of claim 17, wherein the hierarchy interface is operable for a user to one of create a task, revise a task, re-associate a task with another task, and delete a task.

22. The method of claim 17, wherein the task description interface is operable to allow a user to create a description of a selected task and revise the description of the selected task.

23. The method of claim 17, further comprising presenting an exit criteria interface operable to display results to be achieved for a task to be completed.

24. The method of claim 17, wherein the completion indicator includes a checkbox such that operator actuation of the checkbox signifies that the task is completed.

25. The method of claim 17, further comprising using a graphical user interface such that a user can select a task or a resource using a pointing device.

26. The method of claim 25, further comprising generating a pop-up menu providing a list of options for one of the task and the resource selected by the user.

27. The method of claim 25, further comprising navigation buttons including a forward button allowing the user to step forward to a next task and a backward button allowing the user to step backward to a previous task.

28. The method of claim 17, further comprising providing multiple-user access allowing a plurality of permitted users to monitor the process.

29. The method of claim 28, further comprising a user control interface operable to selectively allow for access for monitoring the process to be granted, revoked, and changed.

30. A computer-readable medium having stored thereon instructions for coordinating and managing a process, the computer-readable medium comprising:
a first computer program portion adapted to identify a task involved in the process;
a second computer program portion adapted to identify at least one resource involved in the task;
a third computer program portion adapted to associate the at least one resource with the task;
a fourth computer program portion adapted to specify a location of the resource from which the at least one resource can be accessed;
a fifth computer program portion adapted to provide a completion indicator by which completion of the task is indicated;
a sixth computer program portion adapted to provide a task review interface by which the completion of the task is ascertainable; and
a seventh computer program portion adapted to provide a resource interface by which resources involved in the task are reviewable.

31. The computer-readable medium of claim 30, wherein the resource is a computer-readable resource stored on a computing system.

32. The computer-readable medium of claim 30, wherein the location of the resource includes a uniform resource locator.

33. The computer-readable medium of claim 30, wherein the process includes a plurality of hierarchically organized tasks such that at least one main task includes at least one subtask including a constituent part of the main task.

34. The computer-readable medium of claim 30, further comprising an eighth computer program portion adapted to present a hierarchy interface operable to display a hierarchy of tasks and subtasks.

35. The computer-readable medium of claim 34, wherein the hierarchy interface is operable to allow the hierarchy of tasks and subtasks to be one of selectively displayed, hidden, collapsed, and expanded.

36. The computer-readable medium of claim 34, wherein the hierarchy interface is operable for a user to one of create a task, revise a task, re-associate a task with another task, and delete a task.

37. The computer-readable medium of claim 30, further comprising a ninth computer program portion adapted to present a task description interface operable to one of allow a user to create a description of a selected task, allow a user to revise the description of the selected task, and display a description of a selected task.

38. The computer-readable medium of claim 30, further comprising a tenth computer program portion adapted to present a resource interface operable to display at least one of an input resource and an output resource.

39. The computer-readable medium of claim 30, further comprising an eleventh computer program portion adapted to present an exit criteria interface operable to display results to be achieved for a task to be completed.

40. The computer-readable medium of claim 30, wherein the completion indicator includes a checkbox such that operator actuation of the checkbox signifies that the task is completed.

41. The computer-readable medium of claim 30, further comprising a twelfth computer program portion adapted to present a graphical user interface such that a user can select a task or a resource using a pointing device.

42. The computer-readable medium of claim 41, further comprising a thirteenth computer program portion adapted to present a pop-up menu providing a list of options for one of the task and the resource selected by the user.

43. The computer-readable medium of claim 42, further comprising a fourteenth computer program portion adapted to present navigation buttons including a forward button allowing the user to step forward to a next task and a backward button allowing the user to step backward to a previous task.

44. The computer-readable medium of claim 30, further comprising a fifteenth computer program portion adapted to provide multiple-user access allowing a plurality of permitted users to monitor the process.

45. The computer-readable medium of claim 44, further comprising a sixteenth computer program portion adapted to present a user control interface operable to selectively allow for access for monitoring the process to be granted, revoked, and changed.

46. A computer-readable medium having stored thereon instructions for coordinating and managing a process, the computer-readable medium comprising:
a first computer program portion adapted to identify a plurality of hierarchically organized tasks involved in the process;
a second computer program portion adapted to present a hierarchy interface operable to display a hierarchy including a plurality of tasks;
a third computer program portion adapted to present a task description interface operable to display a task name and a task description;
a fourth computer program portion adapted to identify at least resource involved in the task;
a fifth computer program portion adapted to associate the at least one resource with the task;
a sixth computer program portion adapted to present a resource interface operable to display the at least one resource when the task is selected by a user;
a seventh computer program portion adapted to provide a completion indicator by which completion of the task is indicated; and
an eighth computer program portion adapted to provide a task review interface by which the completion of the task is ascertainable.

47. The computer-readable medium of claim 46, wherein the resource is a computer-readable resource stored on a computing system.

48. The computer-readable medium of claim 46, wherein the location of the resource includes a uniform resource locator.

49. The computer-readable medium of claim 46, wherein the hierarchy interface is operable to allow the hierarchy of tasks and subtasks to be one of selectively displayed, hidden, collapsed, and expanded.

50. The computer-readable medium of claim 46, wherein the hierarchy interface is operable for a user to one of create a task, revise a task, re-associate a task with another task, and delete a task.

51. The computer-readable medium of claim 46, wherein the task description interface is operable to allow a user to create a description of a selected task and revise the description of the selected task.

52. The computer-readable medium of claim 46, further comprising a ninth computer program portion adapted to present an exit criteria interface operable to display results to be achieved for a task to be completed.

53. The computer-readable medium of claim 46, wherein the completion indicator includes a checkbox such that operator actuation of the checkbox signifies that the task is completed.

54. The computer-readable medium of claim 46, further comprising a tenth computer program portion adapted to present a graphical user interface such that a user can select a task or a resource using a pointing device.

55. The computer-readable medium of claim 54, further comprising an eleventh computer program portion adapted to present a pop-up menu providing a list of options for one of the task and the resource selected by the user.

56. The computer-readable medium of claim 54, further comprising a twelfth computer program portion adapted to present navigation buttons including a forward button allowing the user to step forward to a next task and a backward button allowing the user to step backward to a previous task.

57. The computer-readable medium of claim 46, further comprising a thirteenth computer program portion adapted to provide multiple-user access allowing a plurality of permitted users to monitor the process.

58. The computer-readable medium of claim 57, further comprising a fourteenth computer program portion adapted to present a user control interface operable to selectively allow for access for monitoring the process to be granted, revoked, and changed.

59. A system for coordinating and managing a process, the system comprising:
a task identifier configured to identify a task involved in the process;
a resource identifier configured to identify at least one resource involved in the task;
a resource associator configured to associate the at least one resource with the task;
a resource location specifier configured to specify a location of the resource from which the at least one resource can be accessed;
a completion indicator configured to provide an indication of when a task is completed;
a task review interface configured to allow for ascertainment of completion of the task; and
a resource interface configured to allow for review of resources involved in the task.

60. The system of claim 59, wherein the resource is a computer-readable resource stored on a computing system.

61. The system of claim 59, wherein the location of the resource includes a uniform resource locator.

62. The system of claim 59, wherein the process includes a plurality of hierarchically organized tasks such that at least one main task includes at least one subtask including a constituent part of the main task.

63. The system of claim 59, further comprising a hierarchy interface operable to display a hierarchy of tasks and subtasks.

64. The system of claim 63, wherein the hierarchy interface is operable to allow the hierarchy of tasks and subtasks to be one of selectively displayed, hidden, collapsed, and expanded.

65. The system of claim 63, wherein the hierarchy interface is operable for a user to one of create a task, revise a task, re-associate a task with another task, and delete a task.

66. The system of claim 59, further comprising a task description interface operable to one of allow a user to create a description of a selected task, allow a user to revise the description of the selected task, and display a description of a selected task.

67. The system of claim 59, further comprising a resource interface operable to display at least one of an input resource and an output resource.

68. The system of claim 67, fuirther comprising an exit criteria interface operable to display results to be achieved for a task to be completed.

69. The system of claim 59, wherein the completion indicator includes a checkbox such that operator actuation of the checkbox signifies that the task is completed.

70. The system of claim 59, further comprising a graphical user interface such that a user can select a task or a resource using a pointing device.

71. The system of claim 70, further comprising a pop-up menu providing a list of options for one of the task and the resource selected by the user.

72. The system of claim 70, further comprising navigation buttons including a forward button allowing the user to step forward to a next task and a backward button allowing the user to step backward to a previous task.

73. The system of claim 59, further comprising a multiple-user access interface allowing a plurality of permitted users to monitor the process.

74. The system of claim 73, further comprising a user control interface operable to selectively allow for access for monitoring the process to be granted, revoked, and changed.

75. A system having stored thereon instructions for coordinating and managing a process, the system comprising:
a first computer program portion adapted to identify a plurality of hierarchically organized tasks involved in the process;
a second computer program portion adapted to present a hierarchy interface operable to display a hierarchy including a plurality of tasks;
a third computer program portion adapted to present a task description interface operable to display a task name and a task description;
a fourth computer program portion adapted to identify at least resource involved in the task;
a fifth computer program portion adapted to associate the at least one resource with the task;
a sixth computer program portion adapted to present a resource interface operable to display the at least one resource when the task is selected by a user;
a seventh computer program portion adapted to provide a completion indicator by which completion of the task is indicated; and
an eighth computer program portion adapted to provide a task review interface by which the completion of the task is ascertainable.

76. The system of claim 75, wherein the resource is a computer-readable resource stored on a computing system.

77. The system of claim 75, wherein the location of the resource includes a uniform resource locator.

78. The system of claim 75, wherein the hierarchy interface is operable to allow the hierarchy of tasks and subtasks to be one of selectively displayed, hidden, collapsed, and expanded.

79. The system of claim 75, wherein hierarchy interface is operable for a user to one of create a task, revise a task, re-associate a task with another task, and delete a task.

80. The system of claim 75, wherein the task description interface is operable to allow a user to create a description of a selected task and revise the description of the selected task.

81. The system of claim 75, further comprising an exit criteria interface operable to display results to be achieved for a task to be completed.

82. The system of claim 75, wherein the completion indicator includes a checkbox such that operator actuation of the checkbox signifies that the task is completed.

83. The system of claim 75, further comprising a graphical user interface such that a user can select a task or a resource using a pointing device.

84. The system of claim 83, further comprising a pop-up menu providing a list of options for one of the task and the resource selected by the user.

85. The system of claim 83, further comprising navigation buttons including a forward button allowing the user to step forward to a next task and a backward button allowing the user to step backward to a previous task.

86. The system of claim 75, further comprising a multiple-user access interface allowing a plurality of permitted users to monitor the process.

87. The system of claim 86, further comprising a user control interface operable to selectively allow for access for monitoring the process to be granted, revoked, and changed.
